(19) United States
(12) Patent Application Publication
(10) Pub. No.: US 2015/0332345 A1
(43) Pub. Date: Nov. 19, 2015

(54) ADVERTISEMENT SELECTION AND MODEL AUGMENTATION BASED UPON PHYSICAL CHARACTERISTICS OF A VIEWER

(71) Applicant: INTERNATIONAL BUSINESS MACHINES CORPORATION, Armonk, NY (US)

(72) Inventors: Timothy LYNAR, Kew (AU); Suraj PANDEY, Parkville (AU); Anna PHAN, Carlton (AU); John WAGNER, Carlton (AU)

(73) Assignee: INTERNATIONAL BUSINESS MACHINES CORPORATION, Armonk, NY (US)

(21) Appl. No.: 14/277,296

(22) Filed: May 14, 2014

(51) Int. Cl. G06Q 30/02; G06K 9/00; H04N 7/18

(52) U.S. Cl. CPC G06Q 30/0271; H04N 7/18; G06K 9/00221

(57) ABSTRACT

People associate with and respond positively to those they perceive to share similar physical appearances. Accordingly, an advertisement for a product or service is selected for rendering on a display based upon a human model having a resemblance to a human viewer. An advertisement may be created with several different models having varying physical characteristics. Physical characteristics of the viewer are compared with each model and the advertisement chosen based upon the model that more closely resembles the viewer. Furthermore, physical characteristics of a model may be augmented to more closely resemble physical characteristics of the viewer. Augmentation includes modifying physical characteristic color, morphing physical characteristics, and enhancing attractiveness of morphed physical characteristics. Accordingly, the viewer perceives an advertisement with a model that shares similar physical appearances thereby potentially enhancing the effectiveness of the advertisement and a corresponding acquisition of the advertised product or service by the viewer.

### BACKGROUND

The present description generally relates to the selection and augmentation of images of models rendered on a display that are used for the advertisement of products or services.

Viewers of advertisements may be less inclined to be receptive to the message of the advertisement if a person acting as a model communicating the message does not share similarities with the viewer of the advertisement. A viewer may be less receptive to the message if the model communicating the messages does not appear to have a relationship with the model. For example, if the model appeared to be from a different geographic region or has different physical features, then the viewer may be less receptive to the message of the advertisement.

Generally, advertisers strive to use models that a wide range of viewers find attractive. Algorithms and characteristics for determining the attractiveness of a model have been developed and are based on a number of physical characteristics including a person's symmetry and physical proportions. However, it is also widely accepted that on an individual basis, “beauty is in the eye of the beholder.” Thus, a physical characteristic that one person finds attractive may lead to contradictory finding by another person. Nevertheless, attractive models tend to be more successful at presenting an advertising message to a large audience scale, even though such models may be less successful on an individual viewer scale.

### SUMMARY

Research shows that people associate with and respond positively to those they perceive to share similar physical appearances. This disclosure describes augmentation of an image used in advertising on an individual basis. Physical characteristics of a viewer of an advertisement are determined and an advertisement image adapted to the viewer's physical characteristics is presented in response. An advertisement for a product or service may be comprised of several images using several different models, each model having different physical characteristics, and an image selected based upon a closer resemblance between the model and the viewer. Also, an image of the model may be augmented to improve the resemblance between the model and the viewer and enhance the attractiveness of model.

In one example, a method comprises: determining a first subject matter of an image to be rendered on a display and perceived by a viewer of the display; selecting from a multiplicity of images having a multiplicity of models and a plurality of subject matters at least a first image including the first subject matter and a first model having first physical characteristics and a second image including the first subject matter and a second model having second physical characteristics at least partially different from the first physical characteristics; determining a first physical characteristic of the viewer; determining a first resemblance between the first physical characteristic of the viewer and the first physical characteristic of the first model; determining a second resemblance between the first physical characteristic of the viewer and the first physical characteristic of the second model; and selecting, within a digital processing system, the first image for rendering on the display based upon the first resemblance being closer than the second resemblance.

In another example, A method comprises: augmenting a physical characteristic of a model in an advertisement image for rendering on a display for viewing by a viewer having the physical characteristic, the augmenting generating an augmented image with an augmented physical characteristic of the model more closely resembling the physical characteristic of the viewer; enabling display of the augmented image on the display; and enabling the viewer to acquire a product or service advertised by the advertisement image.

In another example, a computer program product comprises: a storage medium readable by a processing circuit and storing instructions for execution by the processing circuit of an application server for performing a method comprising: augmenting a physical characteristic of a model in an advertisement image for rendering on a display for viewing by a viewer having the physical characteristic, the augmenting generating an augmented image with an augmented physical characteristic of the model more closely resembling the physical characteristic of the viewer; enabling display of the augmented image on the display; and enabling the viewer to acquire a product or service advertised by the advertisement image.

### BRIEF DESCRIPTION OF THE SEVERAL VIEWS OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present description, in which:

FIG. 1 shows an example block diagram of system for selecting an advertisement and augmenting a model based upon a resemblance with physical characteristic of a viewer;

FIG. 2 shows an example of differences between a morphed image of a model and a viewer;

FIG. 3 shows an example of differences between a morphed image of a model and the model; and

FIG. 4 shows an example flow diagram of a process for selecting an advertisement and augmenting a model based upon a resemblance with physical characteristic of a viewer.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present disclosure has been presented for purposes of illustration and description, but is not intended to be exhaustive or limited in the form disclosed. Many modifications and variations will be apparent to those of ordinary skill in the art without departing from the scope of the description. The embodiment was chosen and described in order to best explain the principles of the description and the practical application, and to enable others of ordinary skill in the art to understand the description for various embodiments with various modifications as are suited to the particular use contemplated.

The terminology used herein is for the purpose of describing particular embodiments only and is not intended to be limiting of the description. As used herein, the singular forms “a”, “an” and “the” are intended to include the plural forms as well, unless the context clearly indicates otherwise.

The terms “comprises” and/or “comprising,” specify the presence of stated features, steps, operations, elements, and/or components, but do not preclude the presence or addition of one or more other features, integers, steps, operations, elements, components, and/or groups thereof.

The term “image” includes a rendering on an electronic display. An image may include a still photograph or an active video.

The term “model” means a person included within an image and may include a professional actor or actress.

The term “viewer” means a person able to observe an image.

The term “physical characteristic” includes a visible attribute of a model or a viewer and includes, but is not limited to: height, hair color, eye color, skin tone, lip shape, nose shape, ear shape, body shape and/or other body and/or facial features and/or proportions.

The term “advertisement” includes an image having a model conveying a message intended to have a viewer of the image perform an action. The action may include acquisition of a product or service included within the image. The advertisement may be presented as a video on a television screen or a banner on a computer screen or other forms of advertising known to those familiar with the art.

The term “acquisition” includes a purchase, lease or rent of a product or service or an action on a part of a viewer. Such an action includes a click or a selection of an icon included within an advertisement.

The term “morph” includes modification of a physical characteristic of a model included within an image to more closely resemble the same physical characteristic of another person. For example, if the physical characteristic was a nose, and the model had a nose of a first width and another person had a nose of a second width then a morphing of the nose of the model would result in a modified image of the model having a nose having a width between the first width and the second width. Techniques for morphing physical characteristics of persons in images is known to those familiar with the art.

The term “augment” includes modification of one or more physical characteristics of a model included with an image. Modifications includes a morphing and/or a change in color such as a change in eye color, skin color and/or skin tone.

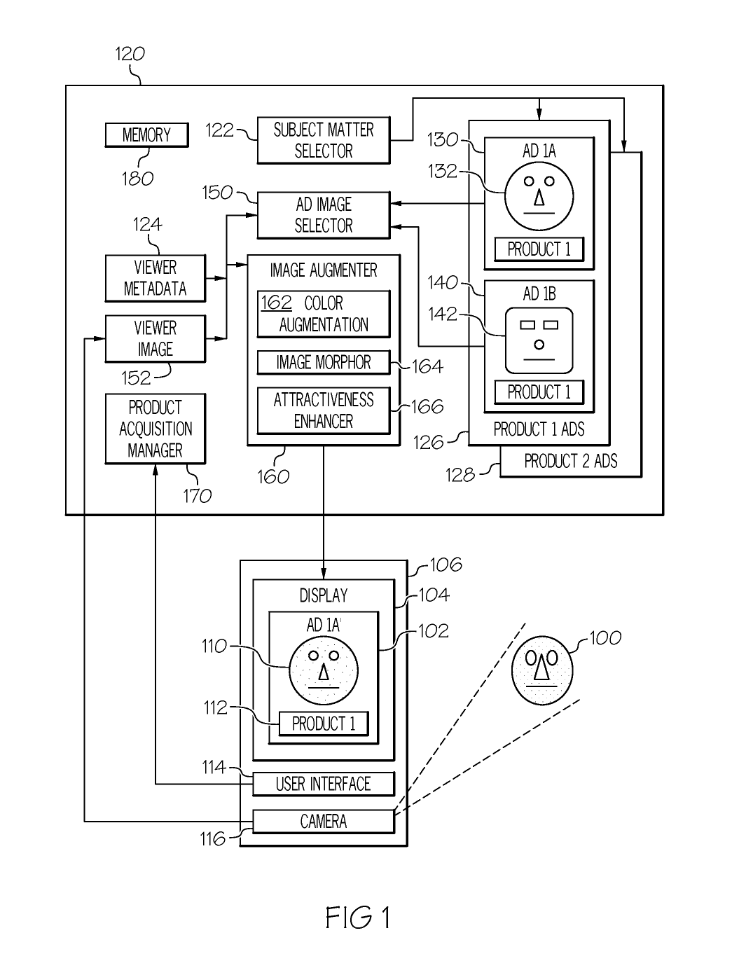

FIG. 1 illustrates an example block diagram of system for selecting an advertisement and augmenting a model based upon a resemblance with physical characteristic of a viewer. A viewer 100 views an image of an advertisement 102 on a display 104 of a device 106. The device may be any device with a display including but not limited to a cell phone, a smart phone, a super phone, a tablet, a laptop, a personal computer, a video game console, a kiosk, and a television. The image of the advertisement includes a model 110 used in the conveyance of a message regarding, in this example, a product 112. The viewer 100 may acquire the product through input on a user interface 114 coupled to or included within device 106. User interfaces are known to those familiar with the art include keys, keyboards, touch pads, touch screens, as well as audio, video and motion transducers and accompanying process and software. Camera 116 optionally captures an image of the viewer 100 including physical characteristics of the viewer.

An advertising server 120 is in communication with the device 106. The communication coupling may be any wired or wireless coupling including Ethernet, internet, cellular, WiFi, and Bluetooth couplings. Subject matter selector 122 selects a subject matter to be advertised to a viewer. The subject matter may be any goods or services, in this example the subject matter selector has selected a subject matter of “product 1”. The product selection may be a targeted advertisement based upon metadata 124 accumulate with respect to the viewer 100, or may be selected by other approaches or processes. Processes for selecting subject matter for advertisement to viewers are known to those familiar with the art. Advertisements consist of a multiplicity of images stored in a memory within the advertising server. In this example the multiplicity of images provide for advertisements for a plurality of products, including images of a first product 126 and images of a second product 128. Two images are shown as advertisements for product 1. The first advertisement 130 is labeled “ad 1A” and includes a model 132 having a round head, round eyes and a triangular nose. The second advertisement 140 is labeled “ad 1B” and includes a model 142 having a rectangular head, rectangular eyes and a round nose. An ad image selector 150 selects one of the plurality images 130 and 140 for product 1 based upon a resemblance between the models of the image and the viewer. The resemblance is determined by comparing at least one physical characteristic of the viewer with a corresponding physical characteristic of the model. The physical characteristic of the viewer may be determined from viewer metadata 124 and/or viewer image 152 received from camera 116. In this example, viewer 100 and model 132 have triangular shaped noses while model 142 has a round nose. Thus, if the nose is the physical characteristic, then model 132 has a closer resemblance to viewer 100 than model 142 because both viewer 100 and model 132 have triangular noses, while model 142 has a round nose. Thus, ad image selector 150 would select image 130 for rendering on the display 104 based upon the resemblance between viewer 100 and model 132 being closer than the resemblance between viewer 100 and model 142.

In another example physical characteristics including eye shape and head shape may be used. Viewer 100 has oval eye and head shapes. Model 132 has round eye and head shapes while model 142 has rectangular eye and head shapes. Ovals resemble circles more than rectangles because a circle may be viewed as a symmetrical oval having no straight lines, while rectangles resemble ovals less than circles because rectangles have straight lines. Thus, model 132 has a resemblance to viewer 100 that is closer than the resemblance between model 142 and viewer 100. Thus, ad image selector 150 would select image 130 for rendering on the display 104 based upon the resemblance between viewer 100 and model 132 being closer than the resemblance between viewer 100 and model 142 if eye and face shape were the physical characteristics. Many other processes and techniques for determining a degree of similarity between persons in images are known to those familiar with the art and are considered to be included within the scope of this description.

While FIG. 1 shows an advertisement server having a subject matter memory with advertisements for two products, 126 and 128, in other examples, the subject matter for advertisements may include substantially more than two products. Furthermore, while two images 130 and 140 having two models 132 and 142 are shown for the first product, other example implementations may include substantially more images having substantially more models with substantially more variations in physical characteristics while remaining within the scope of this description. Furthermore, while the examples show a comparison between one or two physical characteristics, in other examples, substantially more than two physical characteristics may be compared in determining a resemblance between the viewer and the model.

In one example embodiment, the advertisement image selected by ad image selector 150 is for rendering on the display 104 without augmentation, thereby eliminating the need for an image augmenter. In another example an ad image may be augmented by image augmenter 160. If a product ad has multiple images, then the image selected by ad image selector may be augmented. If the ad image is selected by another process, such as by subject matter selector selecting a product that has only one image for advertisement, then need for the ad image selector 150 may be eliminated.

Image augmenter 160 includes a color augmenter 162 of modifying a color of a physical characteristic of a model, an image morphor 164 for morphing a physical characteristic of a model, and an attractiveness enhancer for enhancing an appearance of a morphed image of a physical object of a model.

Color augmenter 162 modifies a color of a physical characteristic to improve the resemblance between the viewer and the model in the advertisement image presented on the display. The improved resemblance has the potential to increase the likelihood of a positive response by the viewer to the advertisement. In the example of FIG. 1 the model 132 has a lighter color skin tone and the viewer 100 has a darker color skin tone. Color augmenter 162 modifies the color of the skin tone to make it closer if not equal to the skin tone of the viewer. In the example of FIG. 1 the skin tone of the model 110 in the advertisement 102 displayed on device 106 is darker than the skin tone of the model 132, yet is lighter than the skin tone of the viewer 100. The closer resemblance in skin tone of model 110 has the potential to improve the response to the advertisement by viewer 110 relative to the lighter skin tone of model 132. While color of the physical characteristic of skin tone has been shown in this example, any other physical characteristic associated with the model in the image may be modified including eye color, hair color, and clothing color while remaining within the scope of this description. Processes for modifying colors of physical characteristics of models in images is known to those familiar with the art, and any and all process for modifying colors of physical characteristics of persons included in images are considered to be within the scope of this description.

If a positive response to the advertisement results in an acquisition of the advertised product or service, then product acquisition manager 170 facilitates the acquisition. An acquisition includes a purchase, lease or rent of a product or service or an action on a part of a viewer. Such an action includes a click or a selection of an icon included within an advertisement. Processes for such an acquisition are known to those familiar with the art. Any acquisition process is considered to be within the scope of this description.

The advertising server also includes a memory 180. Memory 180 may include a computer program product that may include a computer readable storage medium (or media) having computer readable program instructions thereon for causing a processor to carry out aspects of the present description.

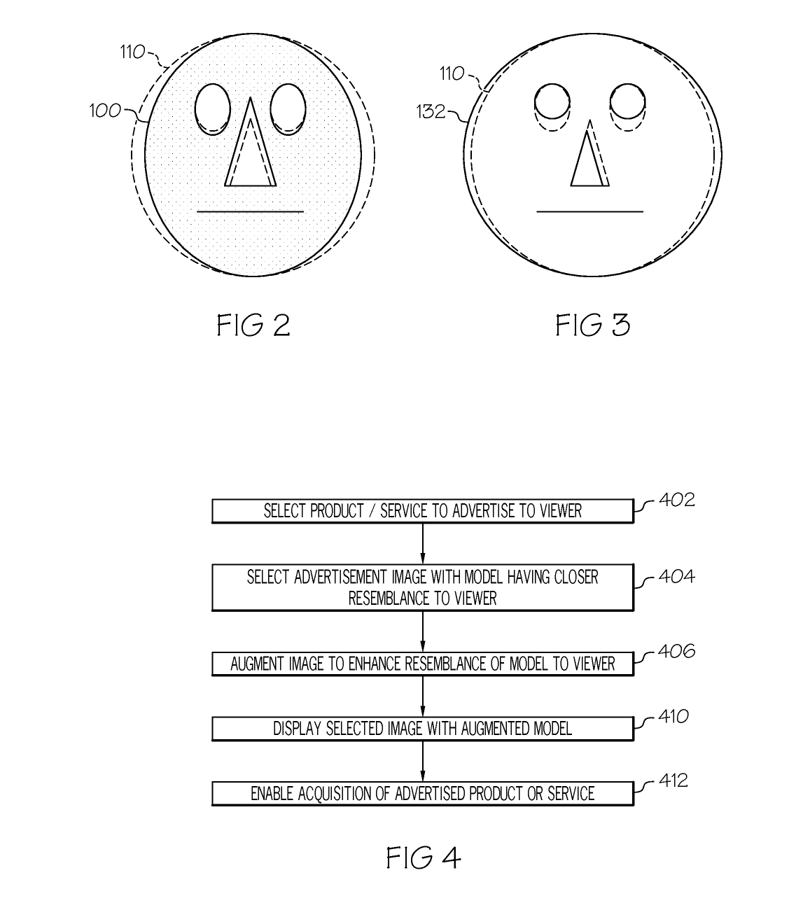

FIG. 2 shows an example of differences between a morphed image of a model and a viewer. FIG. 3 shows an example of differences between a morphed image of a model and the model. FIG. 2 shows the morphed image of the model as dashed line image 110 which corresponds to the image 110 displayed on display 104 of FIG. 1 overlaid on the image of the viewer 100 corresponding to viewer 100 of FIG. 1. FIG. 3 also shows the morphed image of the actor as dashed line image 110 which corresponds to the image 110 displayed on display 104 of FIG. 1 overlaid upon the image of the model 132 of image 130 of FIG. 1. Note that the head of the morphed model 110 is wider than the head of the viewer 100 and narrower than the head of the model 132 as a result of the morphing process performed by image morphor 164. Note further that the eyes of the morphed model 110 are smaller and more circular than the eyes of the viewer 100 and larger than the eyes of the model 132 as a result of the morphing process performed by image morphor 164. Note further that the triangular nose of the morphed model 110 is smaller than the nose of the viewer 100 and larger than the nose of the model 132 as a result of the morphing process performed by image morphor 164. Note that processes for morphing physical characteristics of a person in an image are known to those familiar with the art. All processes for morphing such images are considering to be within the scope of this description.

Further note that FIG. 3 shows the morphed nose of the morphed image 110 to be more centered in the face and between the eyes of image 110. A process included within the attractiveness enhancer 166 is to improve the symmetry of various body features. In this example centering the nose between the eyes of the morphed image improves the symmetry of the morphed image 110, and thus the attractiveness of the morphed image. Thus, instead of placing the morphed nose relative to either the nose of the viewer 100 or the model 132 or a combination of both, attractiveness enhancer determines the placement of the morphed nose based on rules of attractiveness, in this case using a rule of symmetry. Another process included within the attractiveness enhancer 166 is to improve the proportion of the forehead, or in this example to increase the size of the forehead. The eyes of the morphed image are lowered relative to the eyes of the model, rather than centered relative to the eyes of the model to increase the proportion of the forehead size by the attractiveness enhancer. Various approaches for improving the attractiveness of a person are known to those familiar with the art and include at least one of improving a symmetry of physical characteristics of the model of the augmented image, and modifying a nose proportion, a forehead proportion, a cheekbone proportion, and an eyebrow shape of the model of the augmented image. All process for improving the attractiveness of a morphed image are considered to be within the scope of this description.

Thus, the description allows for selection of one of a plurality of images having a first subject matter (or advertisement) based upon at least one physical characteristic of a model in an image including the advertisement having a closer resemblance to the viewer than the physical characteristic of another model in another image. After the image is selected, the resemblance of physical characteristics may be further improved by augmentation. The augmentation includes modifying a color of the physical characteristic, morphing the physical characteristic, and enhancing the attractiveness of the physical characteristic.

While the system of FIG. 1 shows one example of a partition of processes between an advertisement server 120 and a device 106, it should be appreciated that other partitions of the processes of FIG. 1 may be implemented while remaining within the scope of this description. In another example, the image augmenter 160 may be included in device 106 rather than advertisement server 120, thereby allowing for local enhancement of models used in virtually any advertisement presented on display 104. In yet another example, the ad image selector 150 may be incorporated into device 106 with the ad image selector selecting from any of a plurality of ads sent to device 106 from the advertisement server 120. In yet another example, the entire advertisement server process may be incorporated into device 106 while remaining within the scope of this description. Other examples allow for elimination of either the ad image selector or the image augmenter (or portions thereof including either the color augmentation process, the image morphor and or the attractiveness enhancer) while remaining within the scope of this description.

FIG. 4 shows an example flow diagram of a process for selecting an advertisement and augmenting a model based upon a resemblance with physical characteristic of a viewer. Step 402 selects a product or service to be advertised to a viewer. The selection may be based upon an arbitrary selection or may be targeted to the user based upon available data indicating preferences and behaviors of the viewer. Processes for targeting advertising are known to those familiar with the art, and all process for selecting a product or service to be advertised are considered to be within the scope of this disclosure. In this description, a product or service may have several advertisements or images associated with the product or service each having different models with varying physical characteristics. Step 404 selects an advertisement image having a closer resemblance between a model and the viewer. Methods and processes for determining a closeness of resemblance between a person in an image (such as a model) and another person are known to those familiar with the art. All methods for determining resemblance are considered to be within the scope of this description. Step 406 then augments physical characteristics of the model in the advertisement to enhance the resemblance with the viewer. As previously discussed, step 406 includes augmenting a color of a physical feature, morphing a physical feature, and enhancing the attractiveness of a morphed physical feature of the model. In alternate embodiments, either step 404 or step 406 may be eliminated. In step 410 the selected image with the augmented model is displayed, and acquisition of the advertised product or service is enable. The display also enables acquisition of the advertised product. This may include acquisition by placing the advertised item in a digital shopping cart and then facilitating a financial transaction or other transaction leading to the possession of the product by the viewer.

Thus, the description shows a method comprising determining a first subject matter 126 of an image to be rendered on a display 104 and perceived by a viewer 100 of the display by subject matter selector 122. The image is selected from a multiplicity of images 130-140 having a multiplicity of models 132-142 and a plurality of subject matters (product 1 and product 2). The images include at least a first image 130 including the first subject matter of product 1 and a first model 132 having first physical characteristics and a second image 140 including the first subject matter of product 1 and a second model 142 having second physical characteristics at least partially different from the first physical characteristics. Then a first physical characteristic of the viewer, such as the nose of the viewer is determined. An ad image selector 150 then determines a first resemblance between the first physical characteristic (or nose) of the viewer 100 and the first physical characteristic (or nose) of the first model 132. The ad image selector then determines a second resemblance between the first physical characteristic (or nose) of the viewer 100 and the first physical characteristic (or nose) of the second model 142. The ad image selector then selects, within a digital processing system through a process operating within the advertisement server 120, the first image 130 for rendering on the display based upon the first resemblance between the viewer 100 and model 132 being closer than the second resemblance between the viewer 100 and the second model 142. In other words, the nose of the viewer 100 is triangle and has more of a resemblance with the triangular nose of model 132 than the rectangular nose of model 142 and image 130 is selected in response to analyzing the physical characteristics of the noses of the model and the viewer.

The description further shows that the method comprises determining at least a second physical characteristic of the viewer, such as eye and head shape. Then, the first resemblance is further based upon the resemblance between at least the second physical characteristic of the viewer and at least the second physical characteristic of the first model, and the second resemblance is further based upon the resemblance between at least the second physical characteristic of the viewer and at least the second physical characteristic of the second model. In this example the resemblance between the oval shape of the eyes and head of viewer 100 more closely resembles the round shape of the eyes and head of model 132 than the rectangular shape of the eyes and head of model 142. As a result, image 130 is selected in response to analyzing these additional physical characteristics.

The description further shows that the first subject matter selected by subject matter selector 122 is an advertisement for at least one of a product and a service and the digital processing system including the ad image selector 150 for selecting the advertisement is included within advertising server 120. Furthermore, the display 104 is included within a computer system such as device 106 which at least one of a cell phone, a smart phone, a super phone, a tablet, a laptop, a personal computer, a video game console, a kiosk, and a television.

The description also shows that determining the first physical characteristic of the viewer further includes receiving a viewer image of the viewer captured by a device such as camera 116 while the viewer 100 is within a viewing area of the display 104. The description also shows processing the viewer image to determine physical characteristics of the viewer. Note the viewer need not be actually viewing the display during image capture. Since, in the example of FIG. 1 the camera and the display are located within device 106 the viewer should be within the capture range of the camera. The camera provides the ability to capture an image of any user viewing the display and eliminates a need for metadata descriptive of the viewer. For example, if the device 106 was an advertising kiosk in a mall, airport or other areas where there are a large number of different potential viewers, then capturing an image of the viewer allows for selection and augmentation of advertisement models without requiring additional information other than the image of the viewer. This provides for advertisements being having models with physical appearances similar to the physical characteristics of a wide variety of viewers, thereby individualizing the advertisement and possibly increasing the potential for a positive response to the message of the advertisement.

In another example, camera 116 may not be necessary if the first physical characteristic of the viewer is determined based upon metadata 124 associated with the viewer. In this example, the metadata may include a description of physical characteristics of the viewer, such as a triangular nose, oval head and eyes and a darker skin tone. Similarly, availability of metadata associated with models 132 and 142 may eliminate a need to process images 130 and 140 to determine the physical characteristics of the models. For example, if device 106 is a personal device used primarily by a single viewer, such as a smart phone, tablet, or personal computer then the metadata may be accumulated on the viewer over a period of time to better facilitate determination of viewer physical characteristics, either by metadata alone, or in combination with an image from camera 116.

The description also shows that a physical characteristic of the model 132 in the image may be augmented to more closely resemble the corresponding physical characteristic of the viewer 100 by image augmenter 150. In one example, a physical characteristic is a shape such as the nose, and the augmenting includes morphing the shape of the nose of the first model in the first image to more closely resemble the shape of the nose of the viewer as shown in FIG. 2 and FIG. 3.

The description also shows that if the shape of the nose is a first physical characteristic used by ad image selector 150, then image augmenter may augment a second physical characteristic. In one example the shape of the nose may not be augmented. The second physical characteristic includes a color and the augmenting includes changing the color of the second physical characteristic of the first model in the first image to more closely resemble the second physical characteristic of the viewer. The second physical characteristic may be skin tone. The skin tone physical characteristic is different from the first physical characteristic (nose shape) of the first model used to select image 130. Changing the skin tone allows the augmented image to more closely resemble the second physical characteristic of the viewer. Thus, the physical characteristic augmented by image augmenter 160 need not be a physical characteristic analyzed by ad image selector 150. Similarly, in another example, a physical characteristic analyzed by image selector 150 need not be augmented by image augmenter 160. Thus, the physical characteristics analyzed by ad image selector 150 and image augmenter 160 may be independent.

The description also shows a method comprising augmenting a physical characteristic of a model 132 in an advertisement image 130 for rendering on a display 104 for viewing by a viewer 100 having the physical characteristic such as nose shape. The augmenting by image augmenter 160 generates an augmented image 102 with an augmented physical characteristic of the model more closely resembling the physical characteristic of the viewer. The augmented image 102 is then enabled for rendering on the display 104. The viewer 100 is enabled to acquire a product or service advertised by the advertisement image via user interface 114 and product acquisition manager 170. The augmenting further comprises morphing the shape of the physical characteristic of the augmented image to appear as a combination of the shape of the physical characteristic of the model and the shape of the physical characteristic of the viewer as shown by FIG. 2 and FIG. 3. The morphing includes enhancing an attractiveness of the model within the augmented image by attractiveness enhancer 166. Enhancing the attractiveness of the model includes at least one of improving a symmetry of physical characteristics of the model of the augmented image, and modifying a nose proportion, a forehead proportion, a cheekbone proportion, and an eyebrow shape of the model of the augmented image.

The description also shows that the advertisement image 130 selected for augmentation may be selected from a multiplicity of advertisement images 130, 140 advertising a common product or service 126 such as product 1, the multiplicity of advertisement images having a multiplicity of models 132, 142 having varying physical characteristics, the selecting based upon a target physical characteristic of the viewer closely resembling the target physical characteristic of the model of the image. The target physical characteristic may be a nose, or a combination of a nose, eye shape and head shape, or any other single or combination of physical characteristics.

Also, the description shows that a computer program product comprising a storage medium readable by a processing circuit and storing instructions for execution by the processing circuit of an application server for performing the processes and methods described herein.

The present description may be a system, a method, and/or a computer program product. The computer program product may include a computer readable storage medium (or media) having computer readable program instructions thereon for causing a processor to carry out aspects of the present description.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present description may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present description.

Aspects of the present description are described herein with reference to flowchart illustrations and/or block diagrams of methods, apparatus (systems), and computer program products according to embodiments of the description. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present description. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the present application has been presented for purposes of illustration and description, but is not intended to be exhaustive or limited to the description in the form disclosed. Many modifications and variations will be apparent to those of ordinary skill in the art without departing from the scope of the description. The example was chosen and described in order to best explain the principles of the description and the practical application, and to enable others of ordinary skill in the art to understand the description for various examples with various modifications as are suited to the particular use contemplated.

What is claimed is:

1. A method comprising:
determining a first subject matter of an image to be rendered on a display and perceived by a viewer of the display;
selecting from a multiplicity of images having a multiplicity of models and a plurality of subject matters at least
a first image including the first subject matter and a first model having first physical characteristics and
a second image including the first subject matter and a second model having second physical characteristics at least partially different from the first physical characteristics;
determining a first physical characteristic of the viewer;
determining a first resemblance between the first physical characteristic of the viewer and the first physical characteristic of the first model;
determining a second resemblance between the first physical characteristic of the viewer and the first physical characteristic of the second model; and
selecting, within a digital processing system, the first image for rendering on the display based upon the first resemblance being closer than the second resemblance.

2. The method according to claim 1 further comprising:
determining at least a second physical characteristic of the viewer; and
the determining the first resemblance further determines the first resemblance between at least the second physical characteristic of the viewer and at least the second physical characteristic of the first model, and
the determining the second resemblance further determines the second resemblance between at least the second physical characteristic of the viewer and at least the second physical characteristic of the second model.

3. The method according to claim 1 wherein the first subject matter is an advertisement for at least one of a product and a service and the digital processing system selecting the advertisement is included within an advertising server.

4. The method according to claim 3 wherein the display is included within a computer system including at least one of a cell phone, a smart phone, a super phone, a tablet, a laptop, a personal computer, a video game console, a kiosk, and a television.

5. The method according to claim 1 wherein the determining the first physical characteristic of the viewer further includes
receiving a viewer image of the viewer captured while the viewer is within a viewing area of the display, and
processing the viewer image to determine the first physical characteristic of the viewer.

6. The method according to claim 1 wherein the determining the first physical characteristic of the viewer determines the first physical characteristic of the viewer based upon metadata associated with the viewer, the metadata being indicative of the first physical characteristic.

7. The method according to claim 1 wherein the physical characteristics include the first physical characteristic and the physical characteristics include at least one of: height, hair color, eye color, skin tone, nose shape, lips shape, attributes of other body features and attributes of other facial features.

8. The method according to claim 1 further comprises the step of augmenting the first physical characteristic of the first model in the first image to more closely resemble the first physical characteristic of the viewer.

9. The method according to claim 8 wherein the first physical characteristic is a shape and the augmenting includes morphing the shape of the first physical characteristic of the first model in the first image to more closely resemble the first physical characteristic of the viewer.

10. The method according to claim 1 further comprises the step of augmenting a second physical characteristic different from the first physical characteristic of the first model in the first image to more closely resemble the second physical characteristic of the viewer.

11. The method according to claim 10 wherein the second physical characteristic includes a color and the augmenting includes changing the color of the second physical characteristic of the first model in the first image to more closely resemble the second physical characteristic of the viewer.

12. A method comprising:
augmenting a physical characteristic of a model in an advertisement image for rendering on a display for viewing by a viewer having the physical characteristic, the augmenting generating an augmented image with an augmented physical characteristic of the model more closely resembling the physical characteristic of the viewer;
enabling rendering of the augmented image on the display; and
enabling the viewer to acquire a product or service advertised by the advertisement image.

13. The method according to claim 12 wherein the physical characteristic has a shape and the augmenting further comprises
morphing the shape of the physical characteristic of the augmented image to appear as a combination of the shape of the physical characteristic of the model and the shape of the physical characteristic of the viewer.

14. The method according to claim 13 wherein the morphing includes enhancing an attractiveness of the model within the augmented image.

15. The method according to claim 14 wherein the enhancing the attractiveness of the model includes at least one of improving a symmetry of physical characteristics of the model of the augmented image, and modifying a nose proportion, an forehead proportion, a cheekbone proportion, and an eyebrow shape of the model of the augmented image.

16. The method according to claim 12 further comprising: selecting the advertisement image from a multiplicity of advertisement images advertising a common product or service, the multiplicity of advertisement images having a multiplicity of models having varying physical characteristics, the selecting based upon a target physical characteristic of the viewer closely resembling the target physical characteristic of the model of the image.

17. A computer program product comprising:
a storage medium readable by a processing circuit and storing instructions for execution by the processing circuit of an application server for performing a method comprising:
augmenting a physical characteristic of a model in an advertisement image for rendering on a display for viewing by a viewer having the physical characteristic, the augmenting generating an augmented image with an augmented physical characteristic of the model more closely resembling the physical characteristic of the viewer;
enabling display of the augmented image on the display; and
enabling the viewer to acquire a product or service advertised by the advertisement image.

18. The computer programming product according to claim 17 wherein the physical characteristic of the model has a first color and the physical characteristic of the viewer has a second color and the augmenting includes changing the color of the physical characteristic of the model to more closely resemble the first color.

19. The computer programing product according to claim 17 wherein the physical characteristic has a shape and the augmenting further comprises morphing the shape of the physical characteristic of the augmented image to appear as a combination of the shape of the physical characteristic of the model and the shape of the physical characteristic of the viewer.

20. The computer programming product according to claim 17 further comprising:
selecting the advertisement image from a multiplicity of advertisement images advertising a common product or service, the multiplicity of advertisement images having a multiplicity of models having varying physical characteristics, the selecting based upon an at least one target physical characteristic of the viewer closely resembling the at least one target physical characteristic of the model of the image.
